(19) United States
(12) Patent Application Publication
(10) Pub. No.: US 2014/0244900 A1
(43) Pub. Date: Aug. 28, 2014

(54) NON-VOLATILE MEMORY BASED SYSTEM RAM

(71) Applicant: SPANSION LLC, Sunnyvale, CA (US)

(72) Inventors: Tzungren Allan Tzeng, San Jose, CA (US); Jan Silverman, Los Gatos, CA (US)

(21) Appl. No.: 13/781,396

(22) Filed: Feb. 28, 2013

(51) Int. Cl. G06F 12/02

(52) U.S. Cl. CPC G06F 12/0246
USPC 711/103

(57) ABSTRACT

A memory module includes an input/output (I/O) interface adapted to fit into a system random access memory (RAM) socket. The module also includes at least one controller coupled to the I/O interface, the controller comprising a plurality of registers, and a plurality of non-volatile memory devices coupled to the controller. In the module, when data is received at the I/O interface, the received data is stored using at least one of the plurality of registers and the controller performs one of a plurality of non-volatile memory operations on at least a portion of the plurality of non-volatile memory devices based on the received data.

### BACKGROUND OF THE INVENTION

1. Statement of the Technical Field

The invention is directed to the field of memory systems and modules. More particularly, to systems and methods for using non-volatile memory modules as system random access memory (RAM).

2. Description of the Related Art

Conventional computing systems typically comprise a central processing unit, at least one memory controller, and a plurality of memory devices. The memory devices can include temporary and permanent storage devices. The memory devices can include volatile memory devices, such as Dynamic Random Access Memory (DRAM) and Static Random Access Memory (SRAM) devices, and non-volatile memory devices, such as flash memory devices. In most conventional computer architectures, DRAM and SRAM memory devices are connected via a dedicated memory interface and controller, while non-volatile memory devices are typically connected via a separate input/output (I/O) interface. In particular, non-volatile memory devices are generally connected using I/O bridge devices instead of the dedicated memory controller and interface. These interfaces can include PCI-express, SAS, and SATA standard interfaces.

### BRIEF DESCRIPTION OF THE DRAWINGS

Non-limiting and non-exhaustive embodiments of the invention are described with reference to the following drawings, in which:

FIG. 1 is a block diagram of an embodiment of an exemplary computing system operating environment;

FIG. 2 is a block diagram of an exemplary multi-processing unit server system including RAM and non-volatile memory modules in accordance with an embodiment of the invention;

FIG. 3 is a detailed block diagram of an exemplary computing system including a non-volatile memory module in accordance with an embodiment of the invention;

FIG. 4 is a block diagram of an exemplary non-volatile memory module in accordance with an embodiment of the invention;

FIG. 5 is an exploded view of an exemplary non-volatile memory module configured for operating in a byte-slice mode in accordance with an embodiment of the invention;

FIG. 6 is a detailed block diagram of an exemplary computing system configured for operating in memory mapping and transparent modes in accordance with an embodiment of the invention;

FIG. 7 is a detailed block diagram of an exemplary computing system configured for performing copy-back operations in accordance with an embodiment of the invention;

FIG. 8 is a block diagram of an exemplary non-volatile memory module for conceptually illustrating bit scattering in accordance with an embodiment of the invention; and

FIG. 9 is a block diagram of an exemplary non-volatile memory module for conceptually illustrating bit permuting in accordance with an embodiment of the invention.

### DETAILED DESCRIPTION

The invention is described with reference to the attached figures, wherein like reference numbers are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Briefly stated, embodiments of the invention are related to systems and methods for operating non-volatile memory devices as system RAM. As used herein, the term “system RAM” refers to the temporary memory used by a processing element of a computing system for performing system tasks. In particular, a non-volatile memory module compatible with a system RAM memory interface for volatile memory devices is provided. Furthermore, an associated driver is provided for handling operations of the non-volatile memory module in a computing system. The non-volatile memory modules can be configured to operate in address translation mode and/or a transparent mode. In some embodiments of the invention, the non-volatile memory module can be configured to perform copy-back functions for the flash memory devices. In other embodiments of the invention, these non-volatile memory modules are configured to use error detection and correction techniques to improve reliability.

### Operating Environment

In most conventional computer architectures, DRAM and SRAM memory devices are connected via a dedicated memory interface and controller, while non-volatile memory devices are typically connected via a separate input/output (I/O) interface. In particular, non-volatile memory devices are generally connected using I/O bridge devices instead of the dedicated memory controller and interface. These interfaces can include PCI-express, SAS, and SATA standard interfaces.

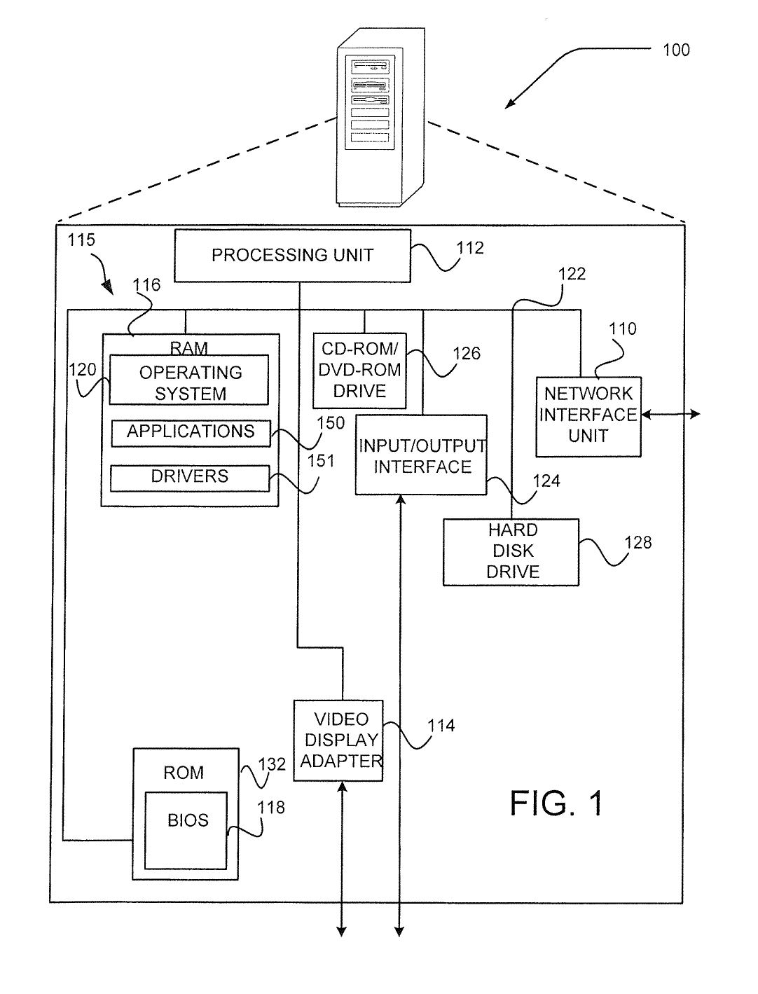

FIG. 1 is a block diagram of an exemplary computing system 100 configured in accordance with an embodiment of the invention. System 100 may include many more components than those shown. The components shown, however, are sufficient to disclose an illustrative embodiment for practicing the invention.

System 100 includes processing unit 112, video display adapter 114, and a mass memory 115, all in communication with each other via bus 122. Processing unit 112 can include one or more processing elements. Mass memory 115 generally includes system RAM 116, read-only memory (ROM) 132, and one or more permanent mass storage devices, such as hard disk drive 128, tape drive, optical drive, and/or floppy disk drive. Any general-purpose operating system may be employed. Basic input/output system (“BIOS”) 118 is also provided for controlling the low-level operation of server 100. As illustrated in FIG. 1, system 100 also can communicate with the Internet, or some other communications network, via network interface unit 110, which is constructed for use with various communication protocols including the TCP/IP protocol. Network interface unit 110 is sometimes known as a transceiver, transceiving device, network interface card (NIC), and the like.

Mass memory 115 as described above illustrates a type of processing unit-readable storage media, which may include volatile, nonvolatile, removable, and non-removable media implemented in any method or technology for storage of information, such as processing unit readable instructions, data structures, program modules, or other data. Examples of processing unit readable storage media include DRAM, SRAM, flash or other semiconductor memory devices, CD-ROM, digital versatile disk (DVD), or other optical storage devices, magnetic cassettes, magnetic tape, magnetic disk storage or other magnetic storage devices. The various embodiments of the invention can also be embodied in any other medium which can be used to store information and which can be accessed by a computing device.

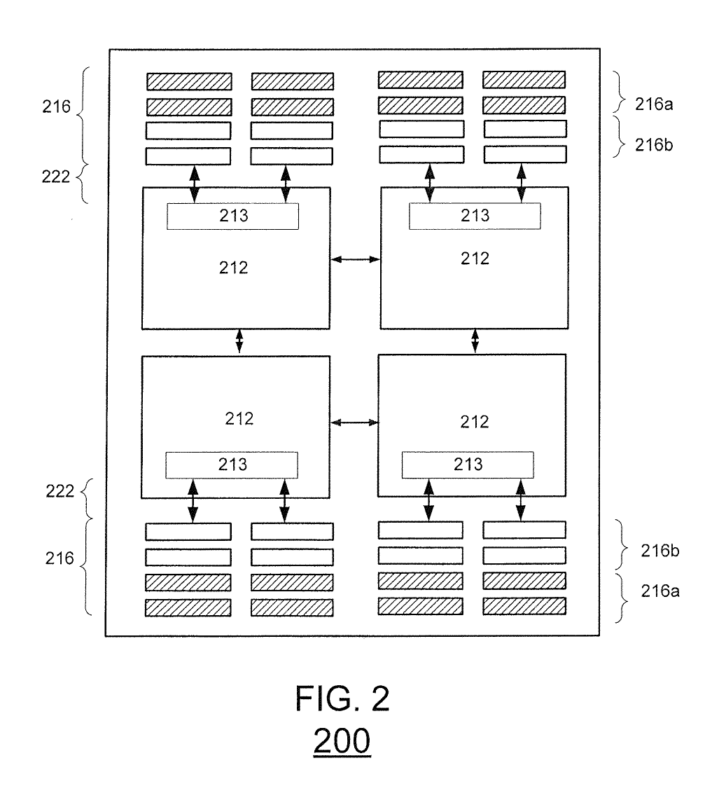

System RAM 116 also stores program code and data. An operating system 120, one or more applications 150, and drivers 151 are loaded into system RAM 116 to operate computing system 100. Examples of application programs include email programs, schedulers, calendars, web services, transcoders, database programs, word processing programs, spreadsheet programs, and so forth. Examples of drivers are video display drivers, memory device drivers, and network interface drivers. In the various embodiments of the invention, system RAM 116 can be provided by a combination of volatile and non-volatile memory modules. This is conceptually illustrated in FIG. 2.

FIG. 2 shows a block diagram of an exemplary computing system 200 in accordance with an embodiment of the invention. System 200 comprises a multi-processing unit server including processing units 212 and system RAM 216. Memory controllers 213 in each of the processing units 212 can be coupled to the system RAM 216 via one or more buses 222. Processing elements 212 can also be interconnected, as shown in FIG. 2. In system 200, any combination of non-volatile memory modules and volatile memory modules can be used for system RAM 216. For example, as shown in FIG. 2, non-volatile memory modules can provide a first portion 216a of system RAM 216 (as indicated by cross-hatched pattern) and volatile memory modules can provide a second portion 216b of system RAM 216.

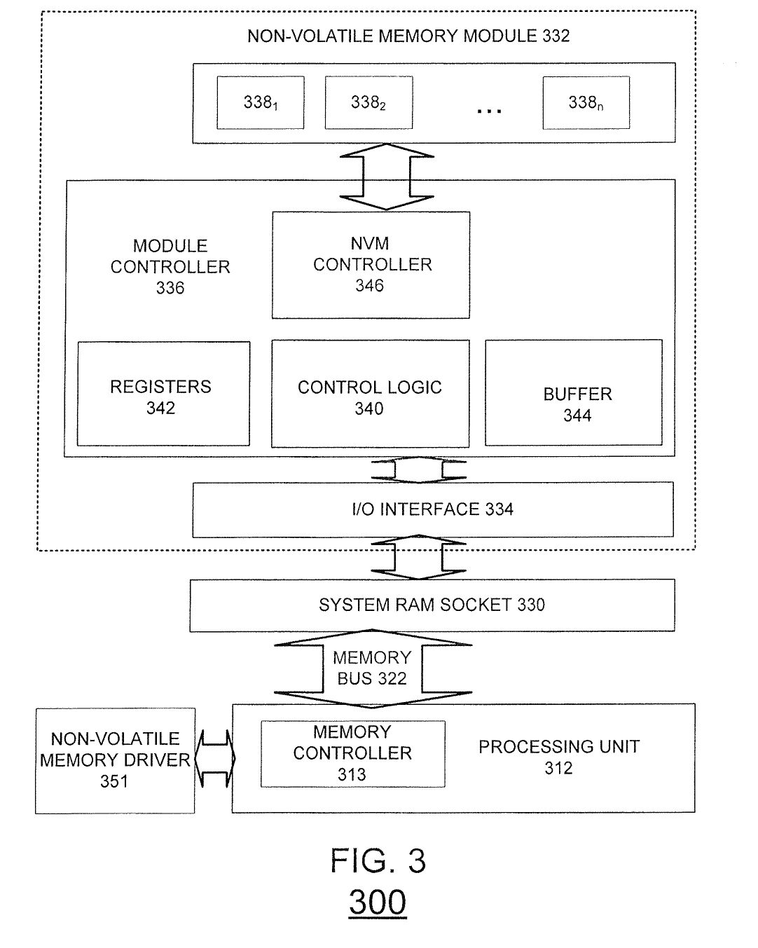

By using a volatile memory interface for connecting non-volatile memory to a computing system, non-volatile memory can be deployed in large quantities in computing systems. Accordingly, in cases where persistent storage of active memory is preferred, the persistent storage is available via a non-volatile memory module accessible via the standard non-volatile interface as opposed to providing and configuring an additional interface. As a result of utilizing the standard volatile interface, the latency needed to access the non-volatile memory by a memory or storage request can be shortened, as volatile memory interfaces typically operate at higher speeds as compared to convention non-volatile memory interfaces. Operation of such non-volatile memory modules installed in volatile memory interfaces will be described below with respect to FIGS. 3-9.

### Memory Module and Driver Architecture

Referring now to FIG. 3, there is provided a detailed block diagram of an exemplary computing system 300 using a non-volatile memory module in accordance with an embodiment of the invention. As shown in FIG. 3, system 300 includes processing unit 312. Processing unit 312 can include a volatile memory controller 313, as described above with respect to FIG. 1. System 300 also includes a system RAM socket 330 communicatively coupled to processing unit 312 via a memory bus 322.

In the various embodiments of the invention, a non-volatile memory module (NVMM) 332 can be coupled to system RAM socket 330 via an input/output (I/O) interface 334 of NVMM 332. System RAM socket 330 and NVMM 332 can be configured to interface in a variety of ways. For example, NVMM 332 can be configured as a dual in-line memory module (DIMM) or a single in-line memory module (SIMM) and system RAM socket 330 can be configured to provide the corresponding interface. In one embodiment, system RAM socket 330 can comprise a double-data-rate three synchronous dynamic DDR3 module receiving socket and non-volatile memory module 322 can be configured to have a dual in-line memory module (DIMM) interface for a DDR3 socket. However, the invention is not limited in this regard and the various embodiments of the invention can be used with any type of system RAM interface.

As shown in FIG. 3, NVMM 332 can include at least one module controller block 336 coupled to non-volatile memory devices 338₁, 338₂, . . . 338ₙ (collectively 338). A “non-volatile memory device”, as used herein, refers to any device including at least one non-volatile memory cell or storage device. In some embodiments of the invention, the non-volatile memory device can comprise a memory module including NAND-type or NOR-type flash memory cells. However, the various embodiments of the invention are not limited in this regard and any type of non-volatile memory can be used in NVMM 332, including any other present or future non-volatile memory technologies.

Controller block 336 can include control logic 340, control registers 342, buffer 344, and non-volatile memory (NVM) controller 346, each of which can be accessible via I/O interface 334. One of ordinary skill in the art will recognize that NVM controller 346 and/or the control logic 340 can be configured to perform one or more memory mapping operations according to the type of non-volatile memory devices. For example, in the case of flash memory devices, the NVM controller 346 and/or control logic 340 can maintain a memory table for mapping addresses during read, program, and erase operations. Although blocks 340-346 are shown as separate components, this is for illustrative purposes only. In some embodiments of the invention one or more of these components may be implemented in a single device or block.

In the various embodiments of the invention, NVMM 332 can be implemented as one or more integrated circuits. For example, in one embodiment, module controller 336 can be provided by mounting at least one application specific integrated circuit (ASIC) die, implementing all functions and blocks shown in controller block 336, and at least one non-volatile memory integrated circuit (IC) die, including non-volatile memory devices 338, on a printed circuit board (PCB) having an interface 334 configured to engage with system RAM socket 330. However, the various embodiments of the invention are not limited to any type of form factor or module design. For example, the various embodiments of the invention can be used with DIMM or SIMM designs, as described above, or any other conventional and future memory module designs and/or form factor.

In operation, NVMM 332 operates by receiving memory command information at I/O interface 334 from processing unit 302 (i.e., by operating the memory controller 303 in accordance with non-volatile memory driver 351). Once this information is received at NVMM 332, module controller 336 can then process the information and execute the appropriate non-volatile memory command in non-volatile memory 338. In the various embodiments of the invention, memory command information can be received and/or processed at NVMM 332 in various ways. For example, in some embodiments of the invention, the module controller 336 can be configured to operate in a translation mode and/or a transparent mode.

In a transparent mode, the information received at NVMM 332 can be received in a foam that can be directly used by NVM controller 346. That is, information can be written directly to registers 342 in a format and at locations in registers 342 such that NVM controller 346 needs only access the information in registers 342 to perform a non-volatile memory. In such embodiments, a particular location in registers 342 can be associated with a specific type of command for the non-volatile memory devices 338. For example, if devices 338 comprise flash memory devices, separate locations can be associated with each of the flash read, program, and erase commands for these devices. Therefore, the NVM controller 346 can be configured to read data from such locations and interpret the data received in a read or an erase command location as address information and the data received in a program command location as address and data information. In some embodiments, a memory mapping step can also be performed by NVM controller 346 or control logic 340, if necessary.

In a translation mode, the information can be received at only one location in registers 342 and control logic 340 can analyze the received data prior to execution of a memory operation by NVM controller 346. In such embodiments, the memory command received can also include command type information. Based on its analysis of the received memory command information, control logic 340 can determine the command type, address information, and data to be written (if necessary for the command) and then write this information to the appropriate locations in registers 342 for use by NVM controller 346.

Once the memory command information is available for use by the NVM controller 346, the memory command can be performed. First, the module controller can determine the status of the non-volatile memory devices 338. If the non-volatile memory devices 338 are not available for use (i.e., currently performing an operation), NVM controller 346 then waits for the current operation to complete. Once the non-volatile memory devices 338 are available, NVM controller 346 can commence the non-volatile memory operation specified in or by registers 342.

In the various embodiments of the invention, concurrent or overlapping operations are avoided by monitoring the status of the non-volatile memory devices 338 to prevent execution of commands while devices 338 are unavailable, as described above. Therefore, once the non-volatile memory devices 338 are available again, the command can be performed. In the case of a write or erase command, the data is simply written to non-volatile devices 338. In the case of a read command, the data is retrieved from the non-volatile devices and copied to buffer 344. During such a read command, the NVM controller 346 or control logic 340, upon receipt of information indicating a read command for the non-volatile memory devices 338 can also be configured to set a status bit in registers 342 that is accessible via the I/O interface 334. This status bit can be used to indicate that the data is not yet available. Once the data is completely copied to buffer 344, the status bit can be altered by the NVM controller 346 or control logic 340 to indicate that the requested data is now available in buffer 344. Accordingly, this status bit can be used to indicate to the processing unit 302 and/or memory controller 313 when data is ready for use by system 300.

As described above, the memory command information is received at I/O interface 334 from the memory controller 313. In a conventional configuration, a memory command would be translated via a conventional translation mechanism (e.g., a flash translation layer) to generate a corresponding memory command for the non-volatile memory (e.g., converting read and write commands into flash read and program commands). However, direct conversion or translation of such commands via conventional techniques is generally insufficient for purposes of efficiently and correctly utilizing non-volatile memory devices with conventional volatile memory sockets, such as system RAM socket 330. In particular, the timing requirements of a memory bus associated with a conventional system RAM is generally incompatible with the latencies typically associated with most types of non-volatile memory devices, including flash memory devices. For example, if system RAM socket 304 comprises a DDR3 socket, processing unit 302 would generally expect a response from the DDR3 memory installed at system RAM socket 304 within a time period on the order of nanoseconds during a read operation. However, non-volatile memory devices generally operate with much longer latency periods. For example, many flash memory devices typically operate on the order of microseconds. As a result of these timing differences, the use of conventional translation techniques would result in errors. For example, if a read command for a DDR3 memory is translated directly into a flash read command, the requested data from the flash memory would generally not be available within the latency period associated with DDR3 memory devices. As a result, either the incorrect data is retrieved or no data is retrieved.

To overcome such limitations, the various embodiments of the invention also provide a memory driver for accessing non-volatile memory modules according to the timing requirements of system RAM memory buses. In particular, rather than directly translating a volatile memory command in its corresponding non-volatile memory, the various embodiments of the invention provide a memory driver for the memory controller that converts a system RAM operation into one or more memory operations that can be accomplished by the non-volatile module within the timing requirements of the memory bus.

As described above, non-volatile memory module 332 operates by receiving memory command information at I/O interface 334, providing status bit information (for buffer 344) via I/O interface 334, and providing access to buffer 344 via I/O interface 334. These operations effectively correspond to a set of basic memory operations, including a write command (for providing memory command information to module 332), a first read command (for checking the status bit), and a second read command (for reading data from buffer). Since each of these basic operations can be completed at I/O interface 334 without running into any timing issues in the memory bus, memory controller 313 can be configured to convert a conventional volatile memory command into one or more of these basic system RAM operations rather than providing only a directly translated command. This can be accomplished via the memory driver 351.

Memory driver 351 can store instructions for memory controller 313 to convert and handle a memory command from system processing unit 312 into one or more of the basic read and write commands. In operation, system processing unit 312 can generate a request to read or write data from the memory device coupled to system RAM socket 330. The memory controller 313, detecting the type of memory module in socket 330, accesses the appropriate memory driver. In the case of system RAM socket 330 in FIG. 3, the module detected is NVMM 338. Memory controller 313 then accesses memory driver 351 to determine how to handle the request. In the case of a write operation, memory driver 351 can specify to perform only a write operation. In the case of NVMM 332 operating in transparent mode, the data is written directly to the corresponding portion of registers 342, as described above. In general, the likelihood of needing to access stored information within the latency period of the non-volatile memory devices 338 is low, therefore, the memory command information can be written to I/O interface 334 and memory controller 313 can proceed with the next request from processing unit 312. Any overlapping requests are handled internally by the module controller 336, as described above.

In the case of a read command, the timing associated with the memory bus would expect the data to be available within a latency period. Therefore, to avoid issues with the memory bus, the memory driver 351 provides instructions for the memory controller 313 to handle a read request from the processing unit 312 as a series of operations at memory controller 313 instead of as a single, translated read command. In particular, the request can be converted to at least one write operation (to write the corresponding memory command information to I/O interface 334) followed by a series of read operations by memory controller 313. As described above, the NVMM 332 will set a status bit to indicate that data is ready for use. Accordingly, after the write operation is performed, the memory controller 313 will be configured to first perform one or more read operations to read the status bit at I/O interface 334 followed by a read operation to retrieve the data from buffer 344. That is, memory controller 313 is configured by memory driver 351 to continuously read the status bit until set. Once the memory controller 313 detects that the status bit indicates the data is ready, the memory controller 313 can then perform one or more read operations to access the buffer 344 in order to read the requested data from buffer 344.

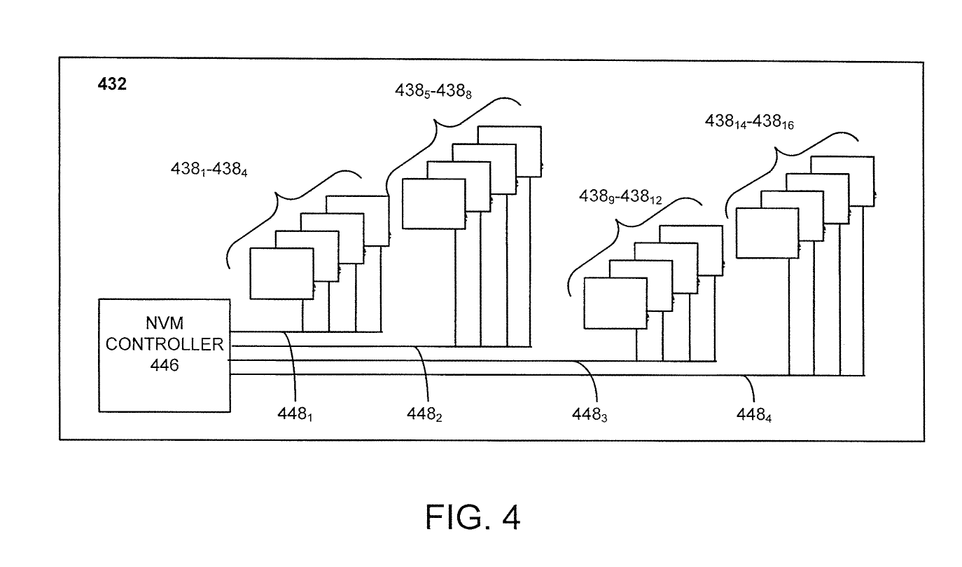

In addition to the normal latency associated with non-volatile memory devices, throughput can also be a significant limitation for utilizing non-volatile memory devices in system RAM. For example, if the data requested is located over a number of different locations or pages in the non-volatile memory, such information is typically retrieved page by page and the latency between receipt of memory command information and the request data being available in the buffer can be extremely high. Therefore, rather than accessing the non-volatile memory devices in a conventional serial or page by page fashion, embodiments of the invention provide for operating the non-volatile memory devices in NVMM 332 as groups that are separately accessible by the controller in the non-volatile memory module. The groups can be configured to execute non-volatile operations simultaneously by dividing the operations into multiple tasks performed in parallel. As a result, the aggregated bandwidth of the multiple groups improves overall access speed and shortening latency. This is conceptually illustrated with respect to FIG. 4.

### Byte-Slice and Distributed Operations

FIG. 4 is a block drawing of a NVMM 432 in accordance with an embodiment of the invention. As shown in FIG. 4, the NVMM module 432 can include NVM controller 446 connected to non-volatile memory devices 438₁-438₁₆ (collectively 438). In module 432, memory devices 438 can be connected in groups to NVM controller 446 to allow simultaneous non-volatile memory operations. For example, as shown in FIG. 4, controller 446 is connected to a first group of non-volatile memory devices 438₁-438₄ (collectively “group A”) via a first common bus 448₁. Controller 446 can also be connected separately to a second group of non-volatile memory devices 438₅-438₈ (collectively “group B”) via a second common bus 448₂. In a similar fashion, controller 404 is also connected separately to a third group of non-volatile memory devices 438₉-438₁₂ (collectively “group C”) via a third common bus 448₃ and to a fourth group of non-volatile memory devices 438₁₃-438₁₆ (collectively “group D”) via a fourth common bus 448₄.

As described above, improved performance for the non-volatile memory devices 438 is achieved by dividing a single non-volatile memory operation into smaller tasks which are simultaneously performed. For example, during a write operation, a data word received at controller 446 is divided up among the groups of memory devices (groups A-D), rather than attempting to write the entire data word to a contiguous space provided by consecutive non-volatile memory devices. A “data word”, as used herein, refers to a sequence or group of bits that are handled together by a computing device. As a result, the write operation results in portions of the data word being written simultaneously to each of groups A-D, rather than the conventional serial writing of pages to a single group of devices. Although the speed of each of these program tasks is relatively slow, the overall program operation is performed more quickly than in convention non-volatile memory modules since the program tasks are performed in parallel.

Further, access to the data word is also significantly improved during a read operation. During the read operation, the requested data word is retrieved by simultaneously accessing each of the groups A-D to retrieve the different portions stored therein. As a result, the different portions of the data word are accessed in parallel, rather than in a serial fashion as in conventional non-volatile memory modules, shortening latency. Although the speed of each of these read tasks is relatively slow, the read operation is performed more quickly than in conventional serial access arrangement of non-volatile memory modules.

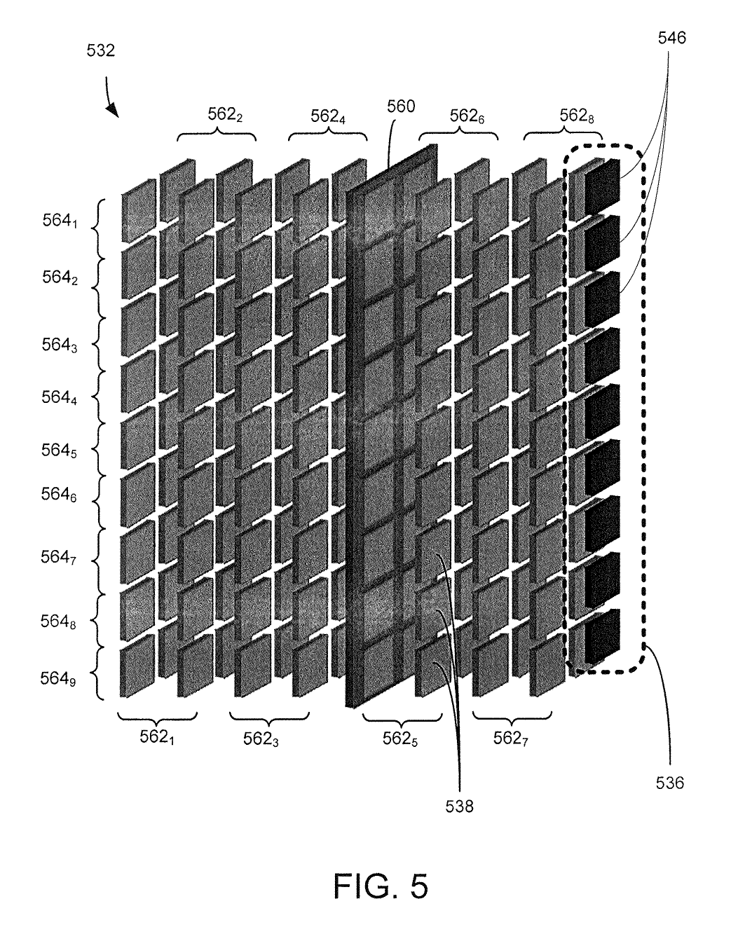

Further improvements in performance can be provided by the use of non-volatile memory devices supporting multiple access (e.g., some NOR non-volatile memories). In such devices, if two or more arrays are accessible via the same connections or bus and at least a first one of the arrays is in use, the other arrays are still accessible via the bus without interfering with the operation of the first array. As a result, groups can be formed and used logically, rather than physically, providing a byte-slice mode of operation. This is conceptually illustrated with respect to FIG. 5.

FIG. 5 shows an exploded view of NVMM 532, configured in accordance with an embodiment of the invention. As shown in FIG. 5, NVMM 532 includes non-volatile memory devices 538 mounted onto PCB 560. Additionally, module 532 includes a controller block 536 including a plurality of module controllers 546 for accessing non-volatile memory devices 538. Each of module controllers 546 configured to access one of portions or byte-slices 564₁-564₉ (collectively 564) of non-volatile memory devices 538 as described above for controller block 336 in FIG. 3. Accordingly, when a memory command, such as a write command, is received by module 532, the corresponding program task is divided among module controllers 546 and the data word to be stored is divided among byte-slices 564.

In embodiments where non-volatile memory devices 538 are configured for multiple access, the non-volatile devices 538 can be accessed as logical devices or groups to allow multiple memory commands to be performed. For example, as shown in FIG. 5, the non-volatile memory devices can be accessed as logical groups 562₁-562₈ (collectively 562). That is, the controller blocks 536 can be configured to perform each non-volatile memory command using only the non-volatile devices associated with one of groups 562₁-562₈. For example, if a write command is received by NVMM 532, the corresponding program task is divided among the controllers 546. The module controllers 546, in turn select one of groups 562₁-562₈ and the data is written to only the non-volatile memory devices in one of byte-slices 564₁-564₉ associated with the selected group. By utilizing these logical groups and multiple access, access times are greatly enhanced by permitting multiple tasks to be simultaneously performed.

For example, if module 532 receives a write command, each of module controllers 546 checks the status of the non-volatile memory devices 538 in the various groups 562. This can be accomplished by interconnecting the various controllers or by providing a central controller (not shown) to review the current operations being performed for the non-volatile devices in each of byte-slices 564. If the module controllers determine that the non-volatile memory devices associated with one of groups 562₁-562₉ are currently not in use, the group is selected and the data word is programmed into the non-volatile memory devices associated with the selected group. During the programming, each of module controllers 546 controls the programming of the portions of the data word for the non-volatile memory devices in each of byte-slices 564₁-564₉. During a subsequent read operation, if the non-volatile memory devices in the group containing the requested data block are currently being used, module controllers 546 proceed with the processing of other received memory commands using other groups in module 532. Once the group storing the requested data word is no longer in use, the data word can be retrieved. During the read, each of module controllers 546 controls the reading of the portions of the data word stored in each of byte-slices 564₁-564₉. Although, this can result in some latency for a particular read command, the overall throughput is improved by allowing controllers 546 to perform other memory commands with idling groups while waiting for the group with the requested data word to become available.

### Erase and Copy Back Operations

In general, some types of non-volatile memory devices have a finite lifetime, such as flash memory cells. That is, the reliability of flash memory cells significantly increases a finite number of reprogramming (i.e., erase operation followed by a write operation) operations. Because of this limitation, conventional flash memory management programs update data words to new locations and mark the old locations for erasure at a later time, typically utilizing erase block tables. Additionally, the location of the updated data is updated in a memory mapping table, typically by remapping file pointers in the memory mapping table.

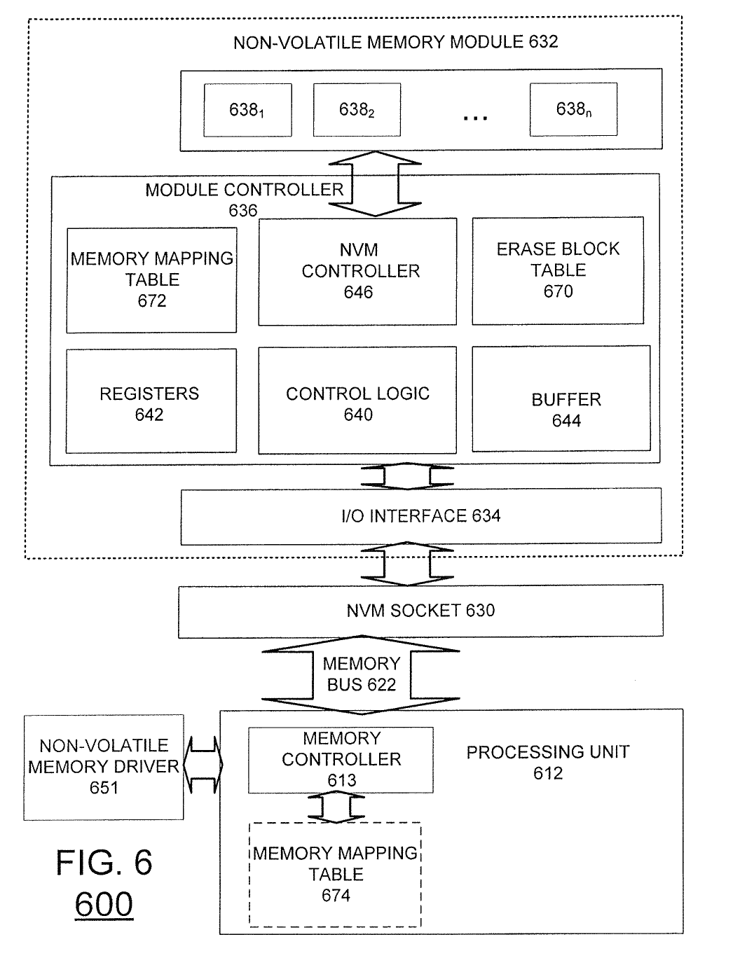

In the various embodiments of the invention, an NVMM module can be configured to perform these erase operations internally and automatically. This is conceptually illustrated in FIG. 6. FIG. 6 shows a detailed block diagram of an exemplary computing system 600 using a non-volatile memory module in accordance with an embodiment of the invention. The configuration of computing system 600 is similar to that of system 300 shown in FIG. 3. System 600 can include a system processing unit 612, a memory controller 613, a memory bus 622, a system RAM socket 630, and a NVMM 632. The NVMM 632 can include an I/O interface 634, a controller block 636, and a plurality of flash memory devices 638₁ . . . 638ₙ (collectively 638). Controller block 636 can include control logic 640, registers 642, buffer 644, and NVM controller 646. Components 612-646 in FIG. 6 are similar to components 312-346 in FIG. 3 and the description above is sufficient for describing the operation of components 612-646.

In addition to the components listed above, controller block 636 can also include erase block table(s) 670. As described above, if a data block stored in devices 638 needs to be modified, the data block is written to a new location within flash memory devices 638. The old locations are then marked by module controller 646 in erase block table 670 in module controller 636. At a later time, such as when NVMM 632 is idle, module controller 646 can be configured to access table 670 and perform erase operations on the portions of devices 638 marked in table 670. These erased portions are then available for future write operations. Although shown as a separate component in controller block 636, the table 670 can be included within other components in block 636. For example, table 670 can be stored in registers 642, control logic 640, or module controller 646.

As previously described, some amount of memory mapping can be required to perform memory operations for volatile memory devices using non-volatile memory devices. This is generally accomplished by providing and maintaining a memory mapping table for a module controller within a NVMM. However, performance of the NVMM can also be enhanced by allowing memory mapping tables to also be maintained outside the NVMM. This is also conceptually illustrated in FIG. 6.

As shown in FIG. 6, the NVMM 632 can maintain a memory mapping table 672 for use by control logic 640 or module controller 642 during memory operations. The memory table provides a mapping of logical memory addresses to actual memory addresses in NVMM 632. The module controller 646 can then use and edit the table 672 during operations. However, in some embodiments of the invention, the driver 651 can also configure the memory controller 313 to maintain a copy of at least a portion of this table outside the NVMM 632 in a memory mapping table 674. Such a configuration allows memory controller 613 to write the memory command information 634 using the actual addresses within the non-volatile memory devices where the requested data is stored. Accordingly, the amount of processing required at NVMM 632 can be reduced and speed of access can be increased for some operations. For example, in the case of NOR flash memories, the read access times can be comparable to DRAM or SRAM access times. Accordingly, during such operations, memory commands can be effectively directly sent to the module controller.

In addition to such erase operations, one of the necessary operations for maintaining reliability and performance of some types of non-volatile memory devices, such as flash memory modules is copy-back. A copy-back operation consists essentially of a read operation from the old location and a write operation to a new location. As previously described, since flash memory cells typically have a limited lifetime, such copy-back operations can be used to evenly wear out the flash memory devices in a flash-based non-volatile memory module. By performing copy-back, circumstances can be avoided in which some memory cells are overused while other memory cells are underused.

In some embodiments of the invention, the controller in the non-volatile memory module can also be configured to provide such a copy-back function. In general, this is accomplished by reading a block of data in locations which have not been sufficiently erased and writing the block of data to a new location. The old locations are then erased. For example, the NVM controller 646 or control logic 640 can be configured to monitor erase block table 670 to determine and/or identify use of the memory cells in devices 638. Based on this identified use, the commands for the NVM controller 646 to move data within devices 638 can be generated.

### Error Checking and Correction

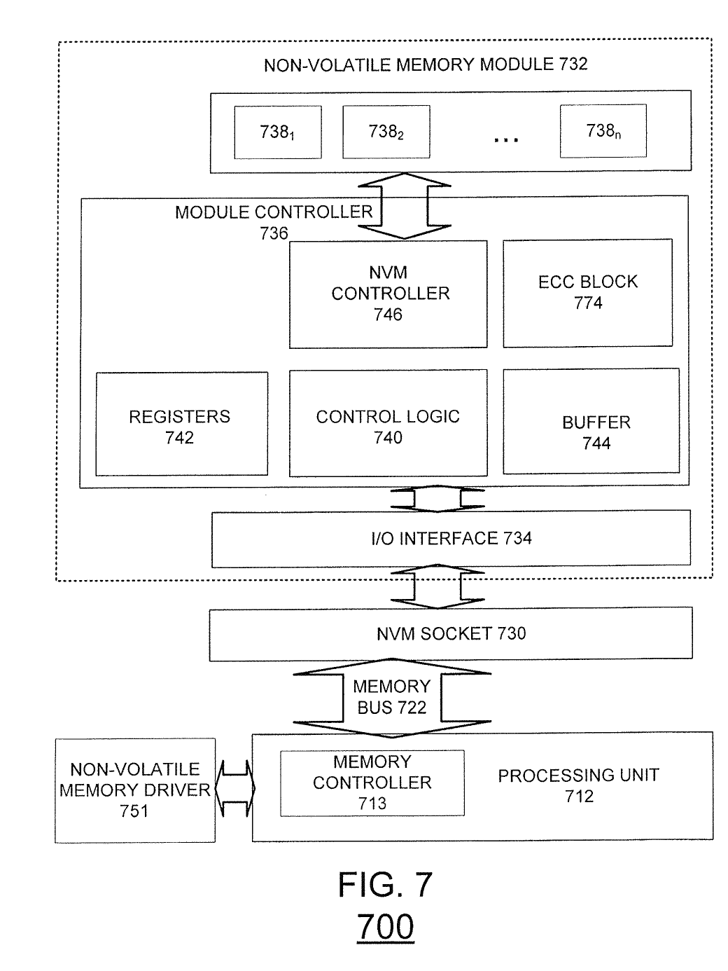

In addition to providing copy-back functions, the non-volatile memory module can also be configured to perform error checking and correction at various levels. In general, a data word written to a RAM module includes bits associated with the data to be written and error correction code (ECC) bits that describe the sequence of bits in the word. Accordingly, when the data word is stored in a non-volatile memory module in accordance with the various embodiments of the invention, the data word also includes the ECC bits. Therefore, during read, write, copy-back, and other operations, error correction can also be performed. This is conceptually illustrated with respect to FIG. 7.

FIG. 7 shows a detailed block diagram of an exemplary computing system 700 using a non-volatile memory module in accordance with an embodiment of the invention. The configuration of computing system 700 is similar to that of system 300 shown in FIG. 3. System 700 can include a system processing unit 712, a memory controller 713, a memory bus 722, a system RAM socket 730, and a NVMM 732. The NVMM 732 can include an I/O interface 734, a controller block 736, and a plurality of flash memory devices 738₁ . . . 738ₙ (collectively 738). Controller block 736 can include control logic 740, registers 742, buffer 744, and NVM controller 746. Components 712-746 in FIG. 7 are similar to components 312-346 in FIG. 3 and the description above is sufficient for describing the operation of components 712-746.

In addition to the components listed above, controller 708 can also include ECC block 774. ECC block 774 can be configured for performing ECC checking and/or correction of a word stored on non-volatile memory devices 738. In operation, when NVM controller 746 begins copy-back operations, module controller 746 selects locations in non-volatile memory devices 738 and reads from the selected locations. In such embodiments, the locations contain a data word, comprising data bits and ECC bits. The read data word can be stored in buffer 744 or other memory location in NVMM 732. The data word can then be provided to ECC block 774 for checking and correction (if necessary), based on the ECC portion. In some embodiments, ECC block 774 can be configured to only detect errors and module controller 746 or control logic 740 can instead be configured to provide the necessary correction. IN other embodiments, ECC block 774 is a part of controller 746 or control logic 740. Once the error checking and correction (if necessary) is completed, module controller 746 can perform a write operation to store the checked (and corrected, if necessary) data word to the new location. Controller block 736 can repeat this process, if necessary, for other locations in non-volatile memory devices 738 to ensure even wearing out of the non-volatile memory devices 738.

In computing systems using ECC, ECC bits are generally written by the memory controller to memory devices along with the data of interest. However, in some embodiments of the invention, an additional layer of ECC protection can be provided for a NVMM to internally detect and correct errors within the non-volatile memory devices. In such embodiments of the invention, additional ECC bits can be generated for each bit to be stored in the non-volatile memory devices. This can also be conceptually described with respect to FIG. 7.

As described above, in response to receiving memory command information at I/O interface 730, the module controller 746 will perform a write command with respect to devices 738 to store the data associated with the memory command information. In some cases, this data can include ECC bits and the ECC bits can be checked using ECC block 774. However, alternatively or in addition to determining the integrity of the data received at NVMM 732, ECC block 774 can be used to add ECC bits. In particular, the NVM controller 746 can access the ECC block 774 during a write operation and generate one or more additional ECC bits prior to storing the data. During any subsequent read or copy back operations, these additional ECC bits can be used to provide error correction in the event of a failure of one of non-volatile memory device 738 and to identify bad areas of such devices. The NVM controller 746 can keep track of these bad areas and prevent any other data words from being written to such areas.

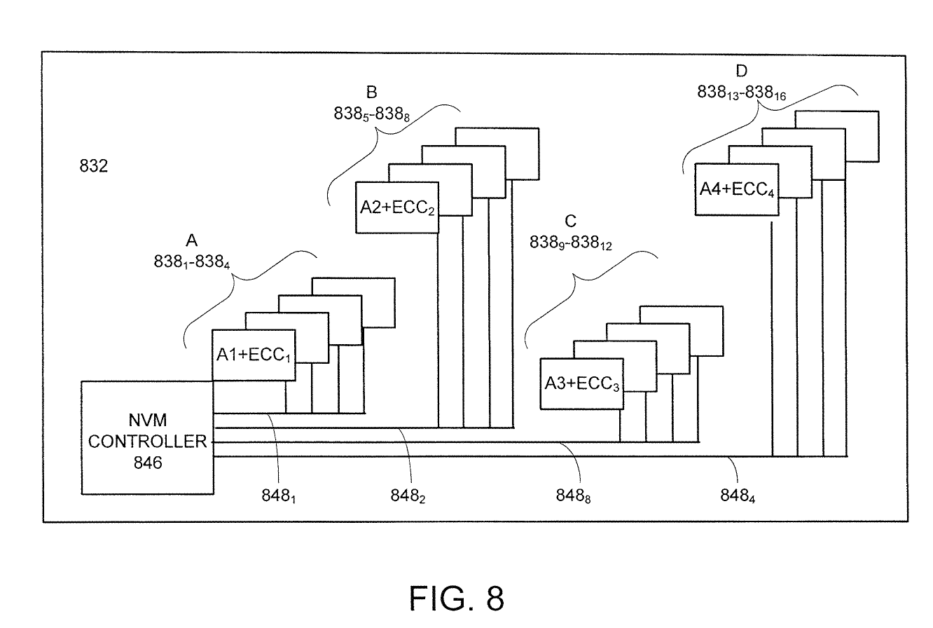

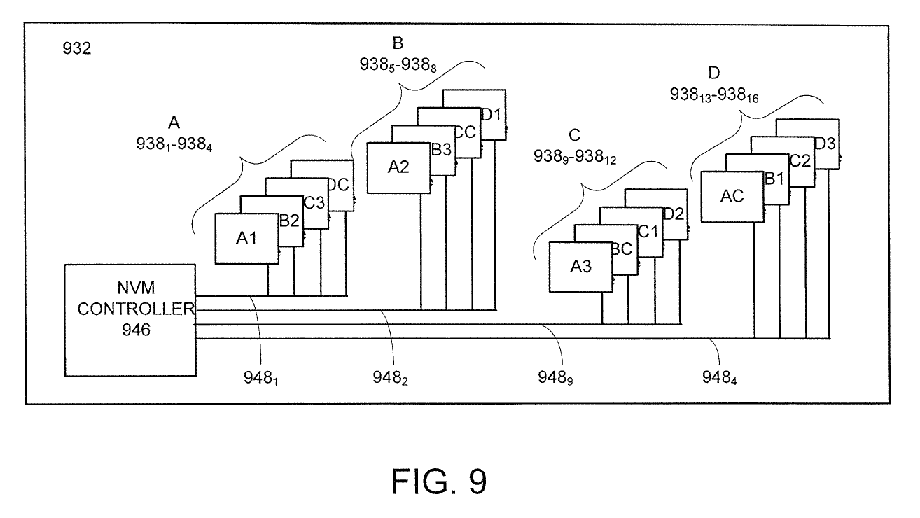

In addition to providing error correction using ECC bits in the data word or by generating ECC bits for the data word to be stored, in some embodiments of the invention, other techniques can be used to provide additional reliability for the non-volatile memory module. In some embodiments of the invention, bit scattering techniques, typically referred to as “Chipkill”, “Advanced ECC”, or “Extended ECC” techniques; improve the reliability of memories by storing at least the ECC bits over several different memory devices. Alternatively or in addition to bit scattering techniques, bit permuting techniques, such as RAID configurations, can be used to store ECC bits. These methods are conceptually illustrated in FIGS. 8 and 9.

FIG. 8 is a block diagram of an exemplary non-volatile memory module 832 for conceptually illustrating bit scattering in accordance with an embodiment of the invention. The arrangement and configuration of module 832 is substantially similar to that of module 432 in FIG. 4. That is, module 832 also includes a controller 846, non-volatile memory devices 838₁-838₁₂ (collectively 838), and buses 848₁-848₄ interconnecting controller 846 and non-volatile memory devices 838. As described above with respect to buses 408 in FIG. 4, buses 848 in FIG. 8 are used to connect controller 846 to the groups A-D of non-volatile memory devices 838. The description of FIG. 4 above is sufficient for describing the basic operation of components in FIG. 8.

In the embodiment in FIG. 8, controller 846 receives a data word, comprising the sequences of bits defined by bit portions A₁, A₂, A₃, A₄, ECC₁, ECC₂, ECC₃, ECC₄, where bit portions A₁-A₄ include data bits and ECC₁-ECC₄ each comprise an ECC bit. To write the data word to non-volatile memory devices 838 and to provide bit scattering, controller 846 divides the data word into multiple data words. In the case of FIG. 8, a received data word is divided into four data words to be stored in each of groups A-D. Furthermore, the four data words are configured such that only one ECC bit is stored in each of non-volatile memory groups A-D. As a result, when controller stores the data word in devices 838₁, 838₅, 838₉, and 838₁₃, only one ECC bit is stored in each of these devices, as shown in FIG. 8. As a result, even if a total failure of one of non-volatile memory groups A-D occurs, substantially all the contents of the entire data word can still be reconstructed, as only one ECC bit is affected by the failure.

Subsequently, during a read operation or a copy-back operation, the controller 846 can be configured to reconstruct the data word or to generate the lost ECC bits. However, the invention is not limited in this regard and data words can be reconstructed elsewhere, such as in the computing system coupled to non-volatile memory module 832.

FIG. 9 is a block diagram of an exemplary non-volatile memory module 932 for conceptually illustrating bit permuting. The arrangement and configuration of module 932 is substantially similar to that of module 400 in FIG. 4. That is, module 932 also includes a controller 946, non-volatile memory devices 938₁-938₁₂ (collectively 938), and buses 948₁-948₄ interconnecting controller 946 and non-volatile memory devices 938. As described above with respect to buses 408 in FIG. 4, buses 948 in FIG. 9 are used to connect controller 946 to the groups A-D of non-volatile memory devices 938. The description of FIG. 4 above is sufficient for describing the operation of components in FIG. 9.

In the embodiment in FIG. 9, controller 946 is configured to write data words using a RAID-5 scheme. However, the invention is not limited in this regard and other RAID schemes can also be used with the various embodiments of the invention. In a RAID-5 scheme, the data bits are written in different permutations to the different groups of non-volatile memory devices 938. For example, as shown in FIG. 9, a first data word, comprising the sequence of bits defined by the bit sequence portions A1, A2, A3, and AC, where AC contains the ECC bits, is stored using non-volatile memory devices 938₁, 938₅, 938₉, and 938₁₃, respectively. The next data word is stored differently in the groups. For example, as shown in FIG. 9, the next data word, comprising the sequence of bits defined by bit sequence portions B1, B2, B3, and BC, where BC contains the ECC bits, is instead stored using non-volatile memory devices 938₁₄, 938₂, 938₆, and 938₁₀, respectively. Similarly, bit sequences C1-CC and D1-DC can be written to the non-volatile memory devices 938 to provide the arrangement of stored bit sequence portions shown in FIG. 9. As a result of such permutations in bit locations, when one of groups A-D fails completely, the data word is either available from the remaining groups or the data word can be reconstructed from the surviving bit sequence portions using the surviving ECC bits.

Subsequently, during a read operation or a copy-back operation, the controller 946 can be configured to reconstruct the data word or to generate the lost ECC bits. However, the invention is not limited in this regard and data words can be reconstructed elsewhere, such as in the computing system coupled to non-volatile memory module 932.

In light of the foregoing description of the invention, it should be recognized that some aspects of the invention can be realized in hardware, software, or a combination of hardware and software. A typical combination of hardware and software could be a general purpose computer processing unit, with a computer program that, when being loaded and executed, controls the computer processing unit such that it carries out the methods described herein. Of course, an application specific integrated circuit (ASIC), and/or a field programmable gate array (FPGA) could also be used to achieve a similar result.

Applicants present certain theoretical aspects above that are believed to be accurate that appear to explain observations made regarding embodiments of the invention. However, embodiments of the invention may be practiced without the theoretical aspects presented. Moreover, the theoretical aspects are presented with the understanding that Applicants do not seek to be bound by the theory presented.

While various embodiments of the invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others having ordinary skill in the art upon the reading and understanding of this specification and the annexed drawings. In addition, while a particular feature of the invention may have been disclosed with respect to only one of several implementations, such features may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

We claim:

1. A memory module, comprising:
an input/output (I/O) interface adapted to fit into a system random access memory (RAM) socket;
at least one controller coupled to the I/O interface, said controller comprising a plurality of registers; and
a plurality of non-volatile memory devices coupled to the controller,
wherein the memory module is configured such that, responsive to receiving data at the I/O interface, the received data is stored using at least one of said plurality of registers and said controller performs one of a plurality of non-volatile memory operations on at least a portion of said plurality of non-volatile memory devices based on said received data.

2. The memory module of claim 1, wherein said system RAM socket includes one of a dynamic random access memory module receiving socket and a static random access memory module receiving socket.

3. The memory module of claim 1, wherein the at least one controller includes a plurality of controllers, each of the plurality of controllers associated with a different portion of said plurality of non-volatile memory devices.

4. The memory module of claim 1, wherein the plurality of non-volatile devices are coupled to the controller to provide a plurality of multiple access non-volatile memory slices, and wherein the controller is configured to manage the plurality of non-volatile memory devices as a plurality of multiple access non-volatile memory groups, each of the plurality of non-volatile memory groups including a different portion of each of said plurality of multiple access non-volatile memory slices.

5. The memory module of claim 1, wherein the plurality of registers include at least first and second registers, wherein said controller is configured to perform a first one of said plurality of non-volatile memory operations responsive to said received data being stored using said first register and a second one of said plurality of non-volatile memory operations responsive to said received data being stored using said second register.

6. The memory module of claim 1, wherein said controller further includes a control logic unit that is configured to determine a one of said plurality of non-volatile memory operations associated with said received data.

7. The memory module of claim 1, wherein the controller further includes an error correction code (ECC) block that is configured to analyze at least one of data words stored in the plurality of non-volatile memory devices and data words to be stored in the plurality of non-volatile memory devices.

8. The memory module of claim 1, wherein the controller further includes an error correction code (ECC) block for performing ECC operations based on at least one of one or more ECC bits generated by said ECC block and one or more ECC bits included in said received data.

9. The memory module of claim 1, wherein at least one status bit in said plurality of registers is accessible via said I/O interface and said controller further includes a buffer accessible via said I/O interface, wherein said controller is further configured for copying retrieved data to said buffer and for setting said status bit in response to said copying.

10. A computing system, comprising:
a processing unit including at least one memory controller;
at least one random access memory (RAM) socket communicatively coupled to said processing element; and
a memory module coupled to said RAM socket, said memory module including a plurality of non-volatile memory (NVM) devices and at least one module controller, said controller including a plurality of registers,
wherein the memory module is configured such that, responsive a memory request from said processing element, said memory controller selects one or more memory operations for said RAM socket, said memory operations selected according to one or more instructions in a driver, and said memory operations including at least write operation for writing data to said RAM socket.

11. The computing system of claim 10, wherein said system RAM socket includes one of a dynamic random access memory module receiving socket and a static random access memory module receiving socket.

12. The computing system of claim 10, wherein said memory module further includes a buffer accessible by said RAM socket for accessing data retrieved from said NVM devices and at least one status bit register,
wherein said memory operations responsive to said memory request include a request to receive data further include at least a first read operation for checking a status bit of said module and at least a second read operation for retrieving data from said buffer if said status bit is set.

13. The computing system of claim 10, wherein the memory module includes a plurality of controllers, each of the plurality of controllers associated with a different portion of said plurality of non-volatile memory devices.

14. The computing system of claim 10, wherein the plurality of non-volatile devices are arranged in said module to provide a plurality of multiple access non-volatile memory slices, and the module is configured to manage the plurality of non-volatile memory devices as a plurality of multiple access non-volatile memory groups, each of the plurality of non-volatile memory groups including a different portion of each of said plurality of multiple access non-volatile memory slices.

15. The computing system of claim 10, wherein the module includes at least first and second registers, wherein said module is configured to perform a first one of said plurality of non-volatile memory operations responsive to said received data being stored using said first register and a second one of said plurality of non-volatile memory operations responsive to said received data being stored using said second register.

16. The computing system of claim 10, wherein said module further includes a control logic unit for determining a one of said plurality of non-volatile memory operations associated with said received data.

17. The computing system of claim 10, wherein said module is configured to maintain a memory mapping table for said non-volatile memory devices, and wherein said processing unit is configured to store a copy of at least a portion of said memory mapping table.

18. A memory module, comprising:
an input/output (I/O) interface adapted to fit into a system random access memory (RAM) socket;
a plurality of non-volatile memory devices; and
controller means for coupling said plurality of non-volatile memory devices to said I/O interface, said controller means including a plurality of registers,
wherein the controller means includes means for, responsive to receiving data at the I/O interface, storing the received data using at least one of said plurality of registers and performing one of a plurality of non-volatile memory operations on at least a portion of said plurality of non-volatile memory devices based on said received data.

19. The memory module of claim 18, wherein the plurality of non-volatile devices are coupled to the controller means to provide a plurality of multiple access non-volatile memory slices, and the controller means includes means for managing the plurality of non-volatile memory devices as a plurality of multiple access non-volatile memory groups, each of the plurality of non-volatile memory groups including a different portion of each of said plurality of multiple access non-volatile memory slices.

20. The memory module of claim 18, wherein the plurality of registers include at least first and second registers, wherein said controller means performs a first one of said plurality of non-volatile memory operations responsive to said received data being stored using said first register and a second one of said plurality of non-volatile memory operations responsive to said received data being stored using said second register.
